(19) United States
(12) Patent Application Publication
(10) Pub. No.: US 2007/0140391 A1
(43) Pub. Date: Jun. 21, 2007

(54) RF COMPLEX BANDPASS-NOTCH FILTER FOR RF RECEIVER AND TV TUNER

(75) Inventor: JIANPING PAN, SAN DIEGO, CA (US)

Correspondence Address: JIANPING PAN, 12925 CAMINITO BESO, SAN DIEGO, CA, 92130, US

(73) Assignee: JIANPING PAN, SAN DIEGO, CA (US)

(21) Appl. No.: 11/609,447

(22) Filed: Dec. 12, 2006

Related U.S. Application Data
(60) Provisional application No. 60/597,806, filed on Dec. 20, 2005.

(51) Int. Cl. H04B 1/10

(52) U.S. Cl. 375/350

(57) ABSTRACT

A complex bandpass-notch filter is disclosed. It provides both bandpass filtering and image rejection, in complex frequency domain, along with a quadrature signal generation. Consequently, this complex bandpass-notch filter provides the both functions of a bandpass filter and a passive polyphase filter. The complex bandpass-notch filter can be used for RF receivers and integrated TV and cable tuners. A low-IF single-conversion integrated tuner and a zero-IF direct-conversion integrated tuner incorporating with this complex bandpass-notch filter are disclosed for terrestrial and cable systems.

### CROSS-REFERENCE TO RELATED APPLICATIONS

This application claims the benefit of U.S. Provisional Patent Application No. 60/597806 filed Dec. 20, 2005; the contents of which are hereby incorporated by reference.

### FILED OF THE INVENTION

This invention relates to bandpass and notch filters used in integrated receivers and integrated tuners used in terrestrial and cable systems for receiving television signals and cable modem signals.

### BACKGROUND OF THE INVENTION

In a tuner or an RF receiver, an RF bandpass filter is typically used in the RF front stage to attenuate interference signals, and it may also attenuate an image signal. In addition, in a tuner, the RF bandpass filter may be a switchable bandpass filter which comprises some or all of conventional LC filters, GmC filters and RC filters and tracks a selected channel in the wide signal band. In a tuner or an RF receiver which uses a single-sideband downconverter to convert the RF signal to a zero-IF or low-IF signal, a polyphase filter may be used to provide certain rejection of an image sideband. The polyphase filter is typically a passive polyphase filter which provides a notch at an image location in either the negative frequencies or the positive frequencies. The polyphase filter is also likely switchable for the tuner use. The benefit of using the polyphase filter in the RF front stage is to cooperate with a following double quadrature converter to provide a potentially high performance in image rejection. Alternatively, the polyphase filter in the RF front stage can cooperate with a single quadrature downconverter which has a quadrature signal input and a real LO signal to create an image rejection downconverter of a moderate image rejection performance.

However, some disadvantages of using the switchable polyphase filter exist which can be summarized as follows. First, it is an extra circuit block, compared to a traditional RF-front stage only using a real-signal RF bandpass filter followed by a single quadrature downconverter which has a real signal input and a quadrature LO signal. Second, a multi-stage passive polyphase filter, acting as a quadrature signal generator having a real signal input and a quadrature signal output, has a large voltage loss. For example, with the identical stages in series, the first stage has a loss of 6 dB, an intermediate stage has a loss of 3 dB, and the final stage may have a loss or gain (−3 dB to 3 dB) depending on the input impedance of a following circuit block. Consequently inter-stage linear amplifiers are normally needed to compensate the loss. Third, the switchable polyphase filter means that the polyphase filter itself has to have the switchable, coarse-tracking mechanism to coarsely track a selected channel signal.

Accordingly, it is the objective of this invention to provide a complex bandpass-notch filter which provides both bandpass filtering and image rejection, in complex frequency domain, along with a quadrature signal generation.

It is another objective of the present invention to provide a low-IF single-conversion integrated tuner incorporating with the complex bandpass-notch filter for receiving analog and digital television signals in terrestrial and cable systems.

It is yet another objective of the present invention to provide a zero-IF direct-conversion integrated tuner incorporating with the complex bandpass-notch filter.

### SUMMARY OF THE INVENTION

A complex bandpass-notch filter is provided in this present invention which provides both bandpass filtering and image rejection, in complex frequency domain, along with a quadrature signal generation. So this complex bandpass-notch filter provides the both functions of a bandpass filter and a passive polyphase filter. The complex bandpass-notch filter can be implemented as a GmC complex bandpass-notch filter and derived from a conventional GmC filter with a minimum modification. The complex bandpass-notch filter can also be implemented as an operational amplifier based complex bandpass-notch filter.

A low-IF single-conversion integrated tuner incorporating with this complex bandpass-notch filter is provided in this present invention for receiving analog and digital television signals in terrestrial and cable systems. The frequency of the low-IF interface can be in the range of 4 to 6 MHz or the popular IF frequency of 36 MHz or 44 MHz. The tuner can interface with digital demodulators having the same low-IF input interface.

A zero-IF single-conversion integrated tuner incorporating with this complex bandpass-notch filter is also provided in this present invention for receiving analog and digital television signals in terrestrial and cable systems. The tuner can interface with demodulators having the baseband input interface.

### BRIEF DESCRIPTION OF THE DRAWINGS

This present invention will be better understood from the following detailed description. Such description makes reference to the accompanying drawings, in which:

FIG. 1 is a semi-schematic diagram of a (second-order) GmC filter, which can be configured as a lowpass filter or a bandpass filter;

FIG. 2 is a semi-schematic diagram of a preferred embodiment of a GmC complex bandpass-notch filter of the present invention, which has a real input and a quadrature output;

FIG. 3 provides an example of frequency response of a GmC complex bandpass-notch filter in both positive and negative frequency domains, where, FIG. 3A provides the frequency response in the positive frequency domain, and FIG. 3B provides the frequency response in the negative frequency domain;

FIG. 4 is a block diagram of a multi-stage GmC complex bandpass-notch filter, as a three-stage example, formed by a first stage of GmC complex bandpass-notch filter and the following stage(s) of GmC complex bandpass filters, which has a real input and a quadrature output;

FIG. 5 is a semi-schematic diagram of a preferred embodiment of a GmC complex bandpass filter;

FIG. 6 provides an example of frequency response of a three-stage Butterworth-like GmC complex bandpass-notch filter in both positive and negative frequency domains, where, FIG. 6A provides the frequency response in the positive frequency domain, and FIG. 6B provides the frequency response in the negative frequency domain;

FIG. 7 provides an example of frequency response of a three-stage Chebyshev-like GmC complex bandpass-notch filter in both positive and negative frequency domains, where, FIG. 7A provides the frequency response in the positive frequency domain, and FIG. 7B provides the frequency response in the negative frequency domain;

FIG. 8 is a semi-schematic diagram of a preferred embodiment of an OpAmp complex bandpass-notch filter having a real input and a quadrature output;

FIG. 9 is a semi-schematic diagram of an embodiment of an OpAmp complex bandpass filter;

FIG. 10 is a block diagram of a preferred embodiment of an integrated tuner of low-IF single-conversion architecture of the present invention, which incorporates with a GmC complex bandpass-notch filter in the RF front stage;

FIG. 11 is a block diagram of a preferred embodiment of an integrated tuner of zero-IF single-conversion architecture of the present invention, which incorporates with a GmC complex bandpass-notch filter in the RF front stage; and

FIG. 12A is a schematic diagram of two-stage passive polyphase filter, which has a real signal input and a quadrature signal output, FIG. 12B is a schematic diagram of two-stage passive polyphase filter, which has a quadrature signal input and a quadrature signal output.

### DETAILED DESCRIPTION OF THE INVENTION

The following definitions and representations are used in this context which also covers the section of claims. A quadrature signal represents a complex signal which has an in-phase component and a quadrature component. In a quadrature—signal processing circuit block, I represents an in-phase component or path and Q a quadrature component or path. A total I/Q mismatch is conveniently defined to represent an equivalent total of I/Q amplitude mismatch and phase error. The total I/Q mismatch satisfies the relationship of A =20log₁₀(B), where B in percentage is the total I/Q mismatch, and A in decibel (dB) is a frequency-crosstalk of a mirror signal to a desired signal. A frequency band represents a frequency range where a radio frequency (RF) signal being received is located. The regular frequency bands in terrestrial TV systems and cable networks are approximately from 50 to 880 Mega-Hertz (MHz). An extended frequency band in cable networks is approximately from 40 MHz to 1 Giga-Hertz (GHz). A channel spacing (a distance between two adjacent channels) in the frequency band is typically 6, 7 or 8 MHz but may be smaller, like for a radio broadcast signal of audio. A local oscillator (LO) signal and a reference signal are equivalent, a reference (or LO) signal represents a reference (or LO) signal of square-wave form, and a frequency of a reference (or LO) signal represents a fundamental frequency of the reference (or LO) signal of square-wave form. A mixer represents a subtractive switching mixer using a square-wave reference (or LO) signal. A converter represents a frequency converter based on subtractive switching mixers and using a real or quadrature reference (or LO) signal, of square-wave form. Three types of conventional quadrature converters in the art will be used later, that is, a double quadrature converter having a quadrature signal input, a quadrature reference input and a quadrature output, a type-I single quadrature converter having a real signal input, a quadrature reference input and a quadrature output, and a type-II single quadrature converter having a quadrature signal input, a real reference input and a quadrature output. A quadrature converter is often conveniently used to represent one of these three quadrature converters. A quadrature converter is a single-sideband frequency converter, that is, it converters a positive or negative sideband of an RF desired signal, as a wanted sideband, into an IF signal. The other sideband of the desired signal becomes the unwanted sideband of the desired signal. In the quadrature conversion, this unwanted sideband of the RF desired signal is an image, mirroring to the wanted sideband. This image is hereby denoted as a self-image, that is, the self-image of the RF desired signal. The frequency or the center frequency of an intermediate frequency (IF) signal represents the center frequency of a desired signal in the IF signal.

In a conventional downconverter in the art, switching mixers which use square-wave reference signals are typically used for achieving large-signal linearity. As a sequence, the downconverter, having a square-wave reference signal, not only converts a desired signal in an RF signal to an IF, but also mixes some other unwanted signals in the RF signal with harmonics of the reference signal into a narrow range at a center frequency of the IF signal, being superimposed on the desired signal in the IF signal. Because these high-order mixing products have the same effect as an image on the desired signal in the IF signal, the unwanted signals in the RF signal corresponding to these high-order mixing products are hereby termed as high-order images. Note that a high-order hereby means an odd- or even-number order higher than the first-order. For example, the third- and fifth-order images being mixed respectively with the third and fifth harmonics of a reference signal are converted to the IF signals. Accordingly an ordinarily-defined image is hereby called as a (first-order) image, a first-order image or simply an image. The differential circuit design is used in this invention in all the circuits wherever it is suitable to reject the common-mode sources and even-order nonlinear distortions, and therefore, all issues related to even-order nonlinear distortions, even-number harmonics and even-number high-order images should be addressed mainly by careful differential circuit designs and proper layout techniques.

This invention presents a complex bandpass-notch filter. It provides both bandpass filtering and image rejection, in complex frequency domain, along with a quadrature signal generation. So this complex bandpass-notch filter provides the both functions of a bandpass filter and a passive polyphase filter. The complex bandpass-notch filter can be derived from a conventional GmC filter with a minimum modification.

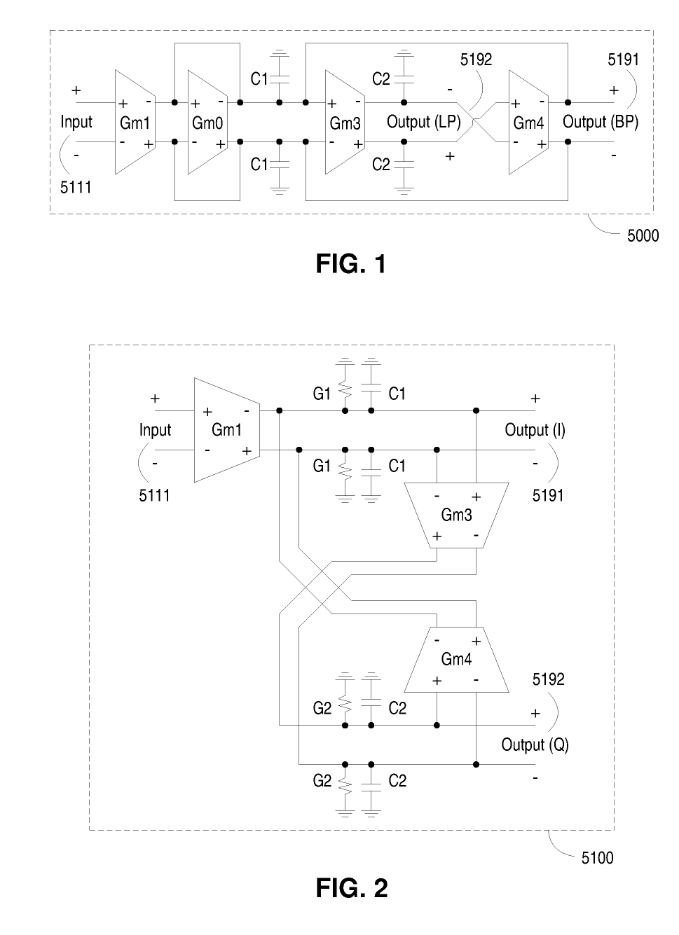

In order to derive the complex bandpass-notch filter, a conventional GmC filter 5000, known in the art, is first illustrated in FIG. 1. There is a real signal input 5111. An output (BP) 5191 is the output of a GmC bandpass filter, and an output (LP) 5192 is the output of a GmC lowpass filter. The frequency responses of these lowpass and bandpass filters are, respectively:

$$\begin{matrix}{H}_{LP} ( s ) = - \frac{\frac{Gm 1 Gm 3}{C 1 C 2}}{{s}^{2} + s \frac{Gm 0}{C 1} + \frac{Gm 3 Gm 4}{C 1 C 2}} & ( 1 ) \\ {H}_{BP} ( s ) = \frac{s \frac{Gm 1}{C 1}}{{s}^{2} + s \frac{Gm 0}{C 1} + \frac{Gm 3 Gm 4}{C 1 C 2}} & ( 2 )\end{matrix}$$

where, the center frequency and quality factor of GmC bandpass filter 5000 are, respectively:

$$\begin{matrix}{ω}_{0} = \sqrt{\frac{Gm 3 Gm 4}{C 1 C 2}} & ( 3 ) \\ {Q}_{0} = \sqrt{\frac{C 1}{C 2}} \frac{\sqrt{Gm 3 Gm 4}}{Gm 0} & ( 4 )\end{matrix}$$

In this context, a conventional GmC filter represents a transconductor-capacitor filter or, furthermore, represents an operational transconductance amplifier (OTA) and capacitor filter. These filters are well known in the art. Hence in FIG. 1, a Gm block represents either a transconductor or an OTA.

In accordance with this invention, a preferred embodiment of a GmC complex bandpass-notch filter 5100 provided in FIG. 2 is directly derived from GmC filter 5000 of FIG. 1. Let Gm0 in FIG. 1 equal to G1 in FIG. 2. Assume G2=0. Note that conductor G1 may be implemented using Gm0 in the way in FIG. 1 for some benefits known in the art. GmC complex bandpass-notch filter 5100 takes a real signal in real signal input, Input 5111. It provides a quadrature signal at its quadrature signal output, represented by Output (I) 5191 and Output (Q) 5192. When G2=0, Output (Q)=−Gm3/(sC2)×Output (I). Therefore, the phase relationship between Output (I) 5191 and Output (Q) 5192 versus frequency is always π/2. At the center frequency of GmC bandpass filter 5000 in FIG. 1 and GmC complex bandpass-notch filter 5100 in FIG. 2, according to Equation (3), Gm3/(ω₀C2)=((Gm3/Gm4) ×(C1/C2))_{1/2}. Therefore, when (Gm3/Gm4)×(C1/C2)=1 satisfied, amplitudes of Output (I) 5191 and Output (Q) 5192 are equal; theoretically, the pair of Output (I) 5191 and Output (Q) 5192 becomes a perfect quadrature signal output of complex bandpass-notch filter 5100. Note that this GmC complex bandpass-notch filter 5100 in FIG. 2 can also be considered as a GmC single-stage complex bandpass-notch filter. When G2=0, Gm4=Gm3 and C2=C1, the following frequency relationships exist:

$$\begin{matrix}{V}_{0}^{I} ( s ) = - {ω}_{a} \frac{{V}_{i} ( s )}{s} - {ω}_{b} \frac{{V}_{o}^{I} ( s )}{s} - {ω}_{c} \frac{{V}_{o}^{Q} ( s )}{s} & ( 5 ) \\ {V}_{0}^{Q} ( s ) = {ω}_{c} \frac{{V}_{o}^{I} ( s )}{s} & ( 6 )\end{matrix}$$

where, ωₐ=Gm1/C1, ω_{b}=G2/C1, and ωc=Gm3/C1, Vᵢ(s) is the (real) input signal at Input 5111, and Vₒ^{I}(s) and Vₒ^{Q}(s) are the quadrature output signals respectively at Output (I) 5191 and Output (Q) 5192.

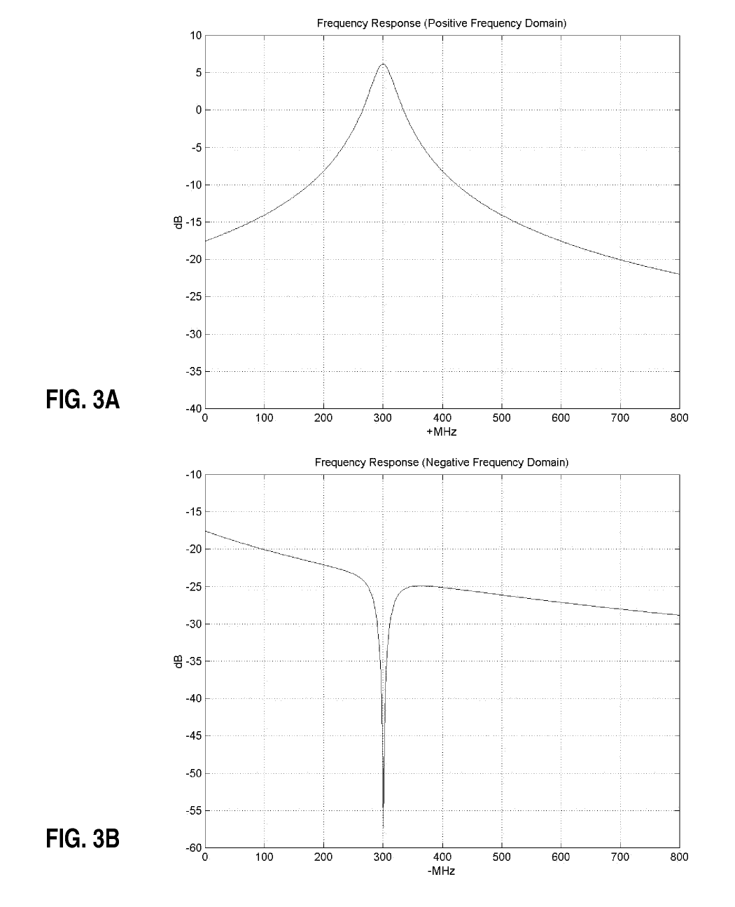

FIG. 3A and FIG. 3B provide an example of frequency response of GmC complex bandpass-notch filter 5100, respectively, in the positive and negative frequency domains. Note that the frequency response corresponds to the real signal input, Input 5111, and the quadrature signal output, Output (I) 5191 and Output (Q) 5192. GmC complex bandpass-notch filter 5100 provides a bandpass filtering with its center frequency at +300 MHz (the positive frequency domain). It also acts as a notch filter and provides a notch at the mirror frequency of the center frequency, −300 MHz (the negative frequency domain). This important character of GmC complex bandpass-notch filter 5100 can be utilized in a zero-IF (single-sideband) downconversion to reject the self-image or in a low-IF (single-sideband) downconversion to reject both the self-image and one sideband of the image which is adjacent to the self-image. Note that locations of the bandpass filtering and the notch in the positive and negative frequency domains can be exchanged by easily changing the connection of the paths across the I and Q signal paths.

Referring to frequency responses of a conventional passive polyphase filter (passive complex notch filter) and a complex bandpass filter (active complex bandpass filter), this disclosed GmC complex bandpass-notch filter 5100 contributes both of their characters, in frequency response. Based on the present process technologies and component matching techniques, the notch frequency of GmC complex bandpass-notch filter 5100 can normally align with the bandpass center frequency in the opposite frequency domain. As typical RF circuit designs, when the center frequency of complex bandpass-notch filter 5100 increases, the parasitic capacitance and resistance in the circuits may ultimately reduce the rejection performance at the notch frequency. Additionally output conductance of Gm amplifiers may influence the frequency response, especially for high-frequency uses.

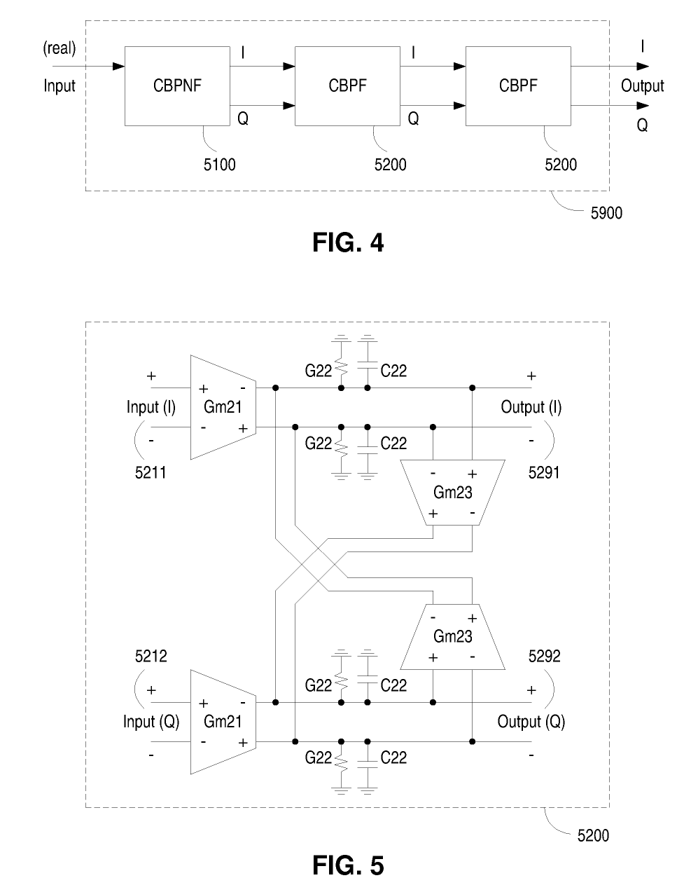

A multi-stage GmC complex bandpass-notch filter, as a three-stage example 5900 depicted in FIG. 4, can be formed by using the first stage of GmC complex bandpass-notch filter 5100 in FIG. 2 and the following stage(s) of GmC complex bandpass filters 5200, each of which has quadrature inputs and outputs. These (single-stage) GmC complex bandpass filters 5200 are typically symmetric, respective to the I and Q signal paths. FIG. 5 provides a preferred embodiment of a (single-stage) GmC complex bandpass filter 5200. In FIG. 5, the respective components in I and Q signal paths are the same but can be different. For the symmetric circuit design, the following frequency relationships exist:

$$\begin{matrix}{V}_{0}^{I} ( s ) = - {ω}_{1} \frac{{V}_{i}^{I} ( s )}{s} - {ω}_{2} \frac{{V}_{o}^{I} ( s )}{s} - {ω}_{3} \frac{{V}_{o}^{Q} ( s )}{s} & ( 7 ) \\ {V}_{0}^{Q} ( s ) = - {ω}_{1} \frac{{V}_{i}^{Q} ( s )}{s} - {ω}_{2} \frac{{V}_{o}^{Q} ( s )}{s} + {ω}_{3} \frac{{V}_{o}^{I} ( s )}{s} & ( 8 )\end{matrix}$$

where, ω₁=Gm21/C22, ω₂=G22/C22, and ω₃=Gm23/C22. 2ω₂ is the double-side bandwidth of GmC complex bandpass filter 5200, and ω₃ is the center frequency. The quality factor is, Qc=ω₃/2ω₂=Gm23/2G22. When GmC complex bandpass-notch filter 5100 in FIG. 2 has symmetric I and Q signal paths except G1 (G2=0), in order for GmC complex bandpass-notch filter 5100 to have a same quality factor as GmC complex bandpass filter 5200 in FIG. 5, G1=2G22 needs to be satisfied, according to Equation (4).

Multi-stage GmC complex bandpass-notch filter 5900 in FIG. 4 comprises two or more stages. In a simple way, the filter stages have the same center frequency. Alternatively, the filter stages can have small frequency offsets to the center frequency of multi-stage GmC complex bandpass-notch filter 5900 to provide enough bandwidth of the filter to cope with the center frequency shift caused by, for example, process variation of the components.

Furthermore, multi-stage GmC complex bandpass-notch filter 5900 in FIG. 4 can be designed optimally to have a Butterworth-like character with good phase linearity or a Chebyshev-like character with a small ripple. The normal way of designing such a multi-stage complex filter is to define the center frequency and quality factor of each filter stage. The following give two examples of such filter design.

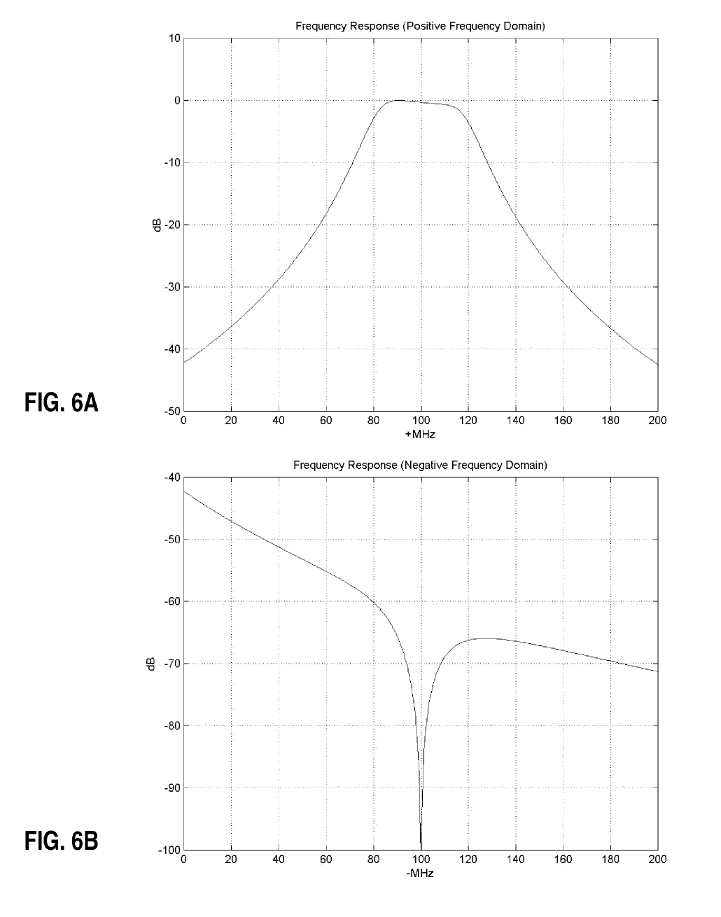

As a first design example of three-stage Butterworth-like GmC complex bandpass-notch filter 5900 in FIG. 4, assume design specifications as: the center frequency is 100 MHz and the one-side bandwidth is 20 MHz. Let C1=C2=C22=C32=4 pF. Then, it can be defined that in the first stage (G2=0), G1=2×0.503×10₋₃(1/Ω), Gm3=2.513×10⁻³ (1/Ω); in the second stage, G22=0.251×10⁻³ (1/Ω), Gm23=2.078×10⁻³ (1/Ω): in the third stage, G32=0.251×10⁻³ (1/Ω), Gm33=2.949×10⁻³ (1/Ω). Gm1, Gm21 and Gm31 only determine the filter gain. Here, C32, G32, Gm33 and Gm31 are the corresponding components in the third-stage complex bandpass filter 5200. The frequency responses of this three-stage Butterworth-like GmC complex bandpass-notch filter 5900 are shown in FIG. 6A, corresponding to the positive frequency domain, and in FIG. 6B, corresponding to the negative frequency domain.

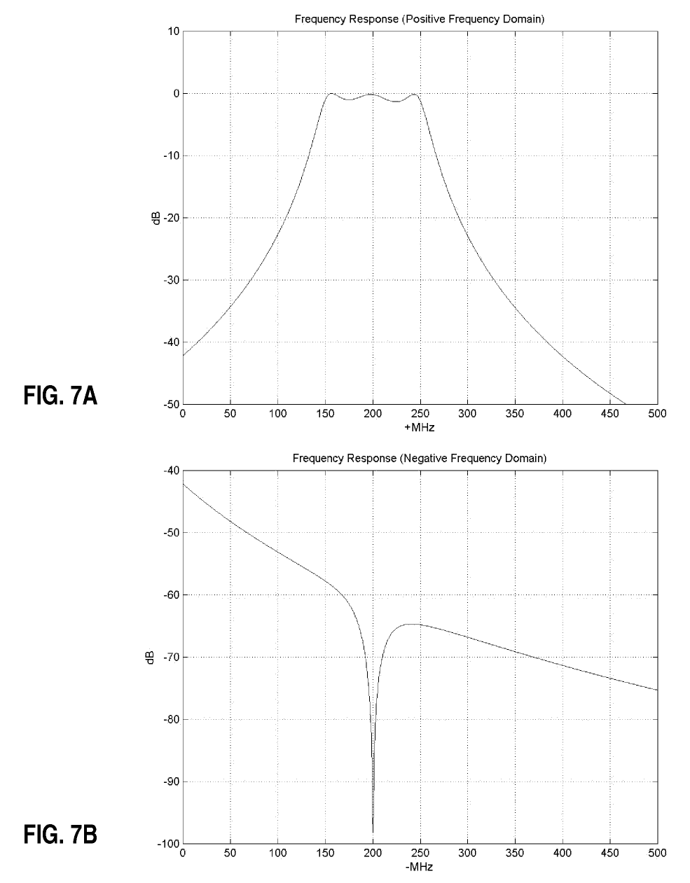

As a second design example of three-stage Chebyshev-like GmC complex bandpass-notch filter 5900 in FIG. 4, assume design specifications as: the ripple in the passband is 1.0 dB, the center frequency is 200 MHz and the one-side bandwidth is 50 MHz. Let C1=C2=C22=C32=3 pF. Then, it can be defined that in the first stage (G2=0), G1 =2×0.466×10⁻³ (1/Ω), Gm3=Gm4=3.770×10⁻³ (1/Ω); in the second stage, G22=0.233×10−3 (1/Ω), Gm23=2.859×10⁻³ (1/Ω); in the third stage, G32=0.233×10⁻(1/Ω), Gm33=4.680×10⁻³ (1/Ω). Gm1, Gm21 and Gm31 only determine the filter gain. The frequency responses of this three-stage Chebyshev-like GmC complex bandpass-notch filter 5900 are shown in FIG. 7A, corresponding to the positive frequency domain, and in FIG. 7B, corresponding to the negative frequency domain.

Note that in these multi-stage GmC complex bandpass-notch filter designs, the notch frequency can be assigned corresponding to the center frequency of any complex filter stage by assigning this stage as the first stage of the multi-stage GmC complex bandpass-notch filter.

A multi-stage GmC complex bandpass filter (without a notch) of a real signal input and a quadrature signal output can be formed by using all the stages of GmC complex bandpass filter 5200 in FIG. 5 in series. Because the input of this multi-stage filter is real (there is not a quadrature input), the unused Gm21 in the quadrature signal path of the first-stage GmC complex bandpass filter 5200 can be removed from the circuit. So the block diagram of this multi-stage GmC complex bandpass filter is similar to FIG. 4 (the difference is that the first stage is also a GmC complex bandpass filter 5200 in this filter). The design of the multi-stage GmC complex bandpass filter is the same as the one described above (but not using G1=2G22).

Transconductors or OTAs in FIG. 2 and in FIG. 5 can be implemented by using a CMOS design. In a GmC filter design, a low quality factor (Q) design is desirable because thermal noise of the filter increases with the increase of Q value and is substantially proportional to the Q value when using a CMOS design. Hence, a BiCMOS or SiGe BiCMOS process can provide a maximum flexibility of the implementation. Many prior-art circuit topologies are available for CMOS, BiCMOS and SiGe BiCMOS designs of OTAs.

Conventional autotuning of a GmC bandpass filter includes a center frequency autotuning and a Q autotuning. These prior-art autotuning techniques herein apply to each stage of multi-stage GmC complex bandpass-notch filter 5900 in FIG. 4.

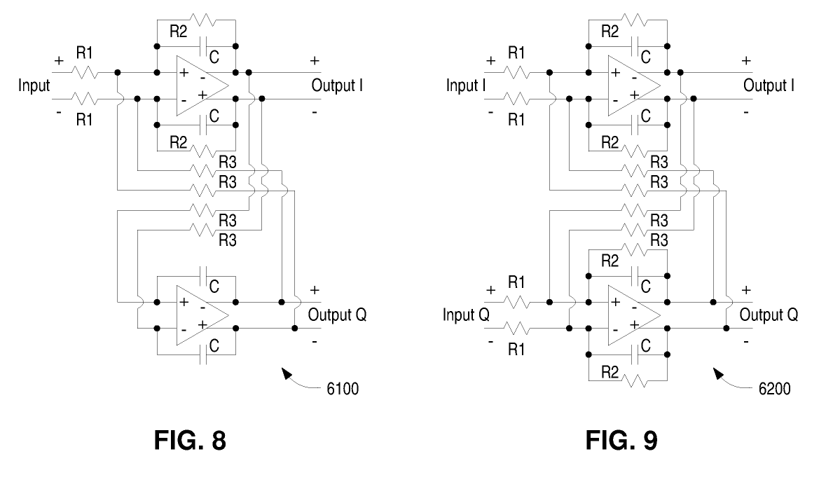

A complex bandpass-notch filter can also be realized using operational amplifiers (OpAmp). FIG. 8 provides an exemplary embodiment of OpAmp complex bandpass-notch filter 6100 having a real input and a quadrature output. An exemplary embodiment of multi-stage complex bandpass-notch filter having a real input and a quadrature output comprises the first stage of OpAmp complex bandpass-notch filter 6100 in FIG. 8 and the following stage(s) of conventional OpAmp complex bandpass filter 6200 illustrated in FIG. 9. The design of this filter is the same as the design of a conventional OpAmp complex bandpass filter known in the art, except that the value of R2 in the first stage needs to be doubled.

An exemplary embodiment of multi-stage complex bandpass filter of a real signal input and a quadrature signal output comprises multiple stages of conventional OpAmp complex bandpass filter 6200 illustrated in FIG. 9, where, in the first stage, the quadrature-signal input, Input Q, and corresponding RI are removed from the circuits. The design of this filter is the same as the design of a conventional OpAmp complex bandpass filter known in the art.

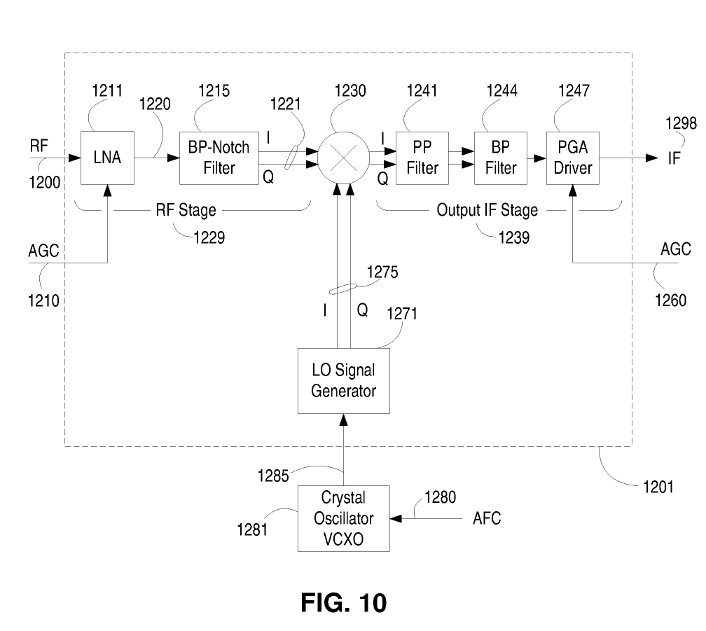

FIG. 10 presents a preferred embodiment of an integrated tuner of low-IF single-conversion architecture 1201 in accordance with the present invention. Integrated tuner 1201 incorporates with the GmC complex bandpass-notch filter disclosed in this invention. A low noise amplifier (LNA) 1211 first amplifies an RF signal 1200. The gain of LNA 1211 is switched by an external automatic gain control (AGC) signal 1210. A complex bandpass-notch filter 1215, a preferred embodiment of GmC complex bandpass-notch filter 5900 provided in FIG. 4, attenuates the high-order images in a downconversion 1230 and some strong interference signals. Complex bandpass-notch filter 1215 also suppresses the self-image of RF desired signal 1200 and a sideband of the (first-order) image in low-IF single-sideband downconversion 1230. Complex bandpass-notch filter 1215 converts real RF signal 1220 input to quadrature RF signal 1221 output. Downconversion 1230 only downconverts the wanted sideband of RF desired signal 1200 to low-IF signal 1239. After low-IF downconversion 1230, an IF polyphase filter 1241 is optionally used to attenuate a low-IF image in low-IF signal 1239. A bandpass filter 1244 provides channel selectivity and interference suppression. A programmable gain amplifier (PGA) in a PGA/Driver 1247 provides AGC functionality, controlled by an external AGC signal 1260. A driver in PGA/Driver 1247 provides an adequate low-IF interface 1298 for demodulators of different applications. The center frequency of low-IF signal 1239 can be in the range of 4 to 6 MHz or a popular IF frequency of 44 MHz or 36 MHz. When the center frequency of low-IF signal 1239 of 44 MHz or 36 MHz is used, complex bandpass-notch filter 1215 may also attenuate the other sideband of the (first-order) image neighboring to the wanted sideband of RF desired signal 1200. A quadrature LO signal generator 1271 provides a quadrature reference signal 1275. A crystal oscillator 1281 generates a reference-source frequency 1285. It may be fine-tuned by an external automatic frequency control (AFC) signal 1280.

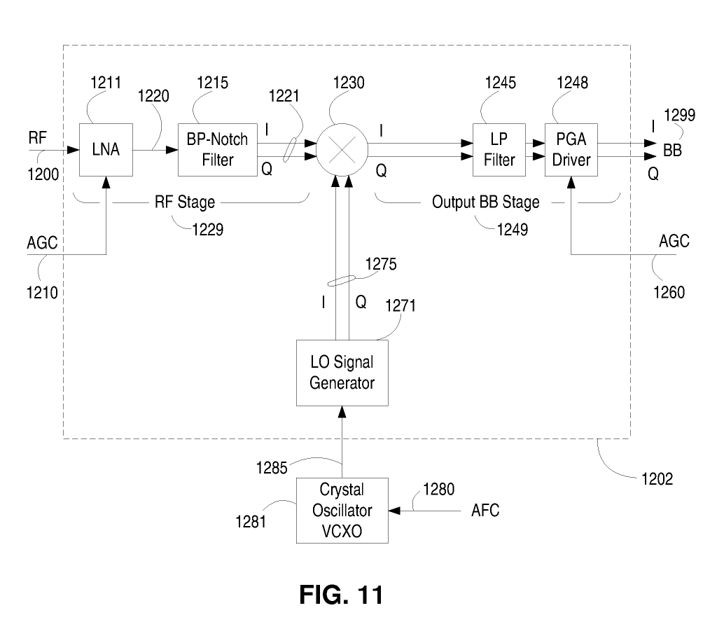

FIG. 11 presents a preferred embodiment of an integrated tuner of zero-IF direct-conversion architecture 1202 in accordance with the present invention. This integrated tuner 1202 incorporates with the GmC complex bandpass-notch filter disclosed in this invention. A low noise amplifier (LNA) 1211 first amplifies an RF signal 1200. The gain of LNA 1211 is switched by an external automatic gain control (AGC) signal 1210. A complex bandpass-notch filter 1215, a preferred embodiment of GmC complex bandpass-notch filter 5900 provided in FIG. 4, attenuates the high-order images in a downconversion 1230 and some strong interference signals. Complex bandpass-notch filter 1215 also suppresses the self-image of RF desired signal 1200. Complex bandpass-notch filter 1215 converts real RF signal 1220 input to quadrature RF signal 1221 output. Downconversion 1230 is a single-sideband zero-IF downconversion which only downconverts the wanted sideband of RF desired signal 1200 to baseband signal 1249. After zero-IF downconversion 1230, a lowpass filter 1245 provides channel selectivity and interference suppression. A programmable gain amplifier (PGA) in a PGA/Driver 1248 provides AGC functionality, controlled by an external AGC signal 1260. A driver in PGA/Driver 1248 provides an adequate baseband interface 1299 for demodulators of different applications. A quadrature LO signal generator 1271 provides a quadrature reference signal 1275. A crystal oscillator 1281 generates a reference-source frequency 1285. It may be fine-tuned by an external automatic frequency control (AFC) signal 1280.

It is reasonable to have an integrated tuner design to include a combination of the integrated tuners disclosed by this invention and conventional integrated tuners in the art.

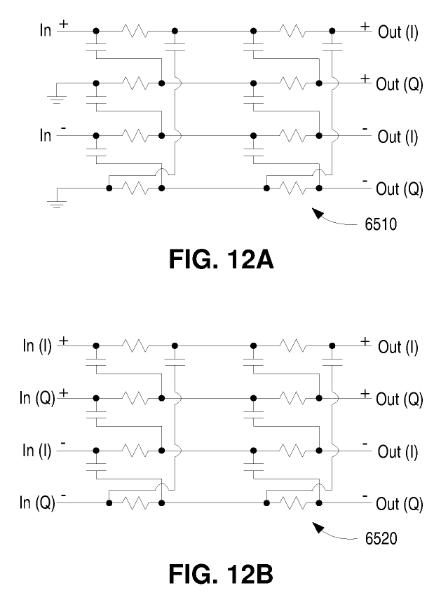

A first exemplary embodiment of such combined design is a zero-IF direct-conversion tuner design. In this tuner design, zero-IF direct-conversion tuner 1202 in FIG. 11 is used for receiving channels in a low-frequency signal subband of the signal band, where GmC complex bandpass-notch filter 5900 in FIG. 4 can work properly in the frequency range. The upper bound of this low-frequency signal subband may be defined as, for example, 500 MHz. A conventional zero-IF direct-conversion tuner known in the art is then used for receiving channels in the higher-frequency signal subband of the signal band. In this conventional zero-IF direct-conversion tuner, an RF LC bandpass filter for attenuating interference signals is used in the RF front stage and a Type-I single quadrature converter is used in the downconversion stage, or an RF LC bandpass filter attenuating interference signals and an RF passive polyphase filter rejecting the self-image are both used in the RF front stage and a double quadrature converter (or a Type-II single quadrature converter) is used in the downconversion stage. An example of two-stage passive polyphase filter 6510 is shown in FIG. 12A, which has a real signal input and a quadrature signal output. Additionally, FIG. 12B shows an example of two-stage passive polyphase filter 6520, which has a quadrature signal input and a quadrature signal output.

A second exemplary embodiment of such combined design is a low-IF single-conversion tuner design, which is very similar to the first exemplary embodiment of such combined design described above.

The integrated tuners disclosed by this invention can be used for TV standards like NTSC, PAL, SECAM, DVB-T, DVB-H, ATSC, ISDB, DMB, MediaFLO, incoming new digital TV standards, etc., and other applications fully or partially using the frequency band of 50 to 880 MHz or 40 MHz to 1 GHz and having a channel spacing of 6 to 8 MHz or smaller. The integrated tuner for receiving FM radio broadcast is a good application considering its low, narrow signal frequency band. Other examples are voice of IP, video conferencing, PC applications, etc. The integrated tuners can also be used for TV applications in other frequency bands or ranges, like DVB-H in the U.S. L-Band, a channel of 1670-1675 MHz, and possibly in the L-Band spectrum for European mobile TV broadcast. Modulation schemes described are only exemplary with this invention not being limited in scope to any particular modulation scheme.

Although the present invention and some embodiments have been described in detail, it should be understood that the aforesaid embodiments illustrate rather than limit the invention, and that various alternative embodiments can be made herein without departing from the spirit or scope of the invention as defined by the appended claims. Although the description above contains many requirements and specifications, these should not be construed as limiting the scope of the invention but as providing illustrations of some of the presently preferred embodiments of this invention. Thus the scope of the invention should be determined by the appended claims.

What is claimed is:

1. A complex bandpass filter having a real signal input and a quadrature signal output, comprising:
a GmC filter; wherein the real signal input of the complex bandpass filter is coupled to an input of the GmC filter, an in-phase (I) component of the quadrature signal output of the complex bandpass filter is coupled to an output of the GmC filter corresponding to bandpass frequency response, and a quadrature (Q) component of the quadrature signal output of the complex bandpass filter is coupled to an output of the GmC filter corresponding to lowpass frequency response; whereby the complex bandpass filter generates the quadrature signal output from the real signal input and has bandpass frequency response in either positive or negative frequency domain and notch frequency response in the opposite frequency domain, the complex bandpass filter applies to RF receivers and TV tuners to both bandpass-filter a desired signal and reject image and other interference signals.

2. The complex bandpass filter of claim 1 wherein the GmC filter is a transconductor-capacitor filter.

3. The complex bandpass filter of claim 1 wherein the GmC filter is an operational transconductance amplifier (OTA) and capacitor filter.

4. The complex bandpass filter of claim 1 wherein the real signal input and the quadrature signal output of the complex bandpass filter are either differential or single-ended, respectively.

5. A multi-stage complex bandpass filter having a real signal input and a quadrature signal output, wherein multiple filter stages connected in cascade, comprising:
a first filter stage having a real signal input and a quadrature signal output and comprising a GmC filter, wherein the real signal input of the first filter stage is coupled to the real signal input of the multi-stage complex bandpass filter; wherein
the real signal input of the first filter stage is coupled to an input of the GmC filter;
wherein an output of the GmC filter corresponding to bandpass frequency response and an output of the GmC filter corresponding to lowpass frequency response are coupled to I and Q components of the quadrature signal output of the first filter stage, respectively;
whereby the multi-stage complex bandpass filter has bandpass frequency response in either positive or negative frequency domain and notch frequency response in the opposite frequency domain and applies to RF receivers and TV tuners to both bandpass-filter a desired signal and reject image and other interference signals.

6. The multi-stage complex bandpass filter of claim 5 further comprising one or more following filter stages; each of the following filter stages having a quadrature signal input and a quadrature signal output and comprising an I-input GmC filter and a Q-input transconductance amplifier and Q-path conductors; wherein the I-input GmC filter has an input, an output corresponding to bandpass frequency response and an output corresponding to lowpass frequency response, wherein the input of the I-input GmC filter is coupled to an I component of the quadrature signal input of the one of the following filter stages and the two outputs of the I-input GmC filter are coupled to I and Q components of the quadrature signal output of the one of the following filter stages, respectively; wherein the Q-input transconductance amplifier has an input coupled to a Q component of the quadrature signal input of the one of the following filter stages and has an output coupled to the Q component of the quadrature signal output of the one of the following filter stages, a terminal of each of the Q-path conductors is coupled to the output of the Q-input transconductance amplifier; whereby the multi-stage complex bandpass filter satisfies different design requirements of filter types and orders.

7. The multi-stage complex bandpass filter of claim 6 wherein the GmC filter and the I-input GmC filter are either transconductor-capacitor filters or operational transconductance amplifier and capacitor filters.

8. The multi-stage complex bandpass filter of claim 7 wherein the I-input GmC filter has an input transconductance amplifier having an input coupled to the I component of the quadrature signal input of the one of the following filter stages; wherein the Q-input transconductance amplifier is identical to the input transconductance amplifier of the I-input GmC filter.

9. The multi-stage complex bandpass filter of claim 8 wherein circuits in I and Q signal paths of the one of the following filter stages are symmetrical.

10. The multi-stage complex bandpass filter of claim 8 wherein the real signal input and the quadrature signal output of the multi-stage complex bandpass filter are differential.

11. The multi-stage complex bandpass filter of claim 8 wherein the real signal input and the quadrature signal output of the multi-stage complex bandpass filter are single-ended.

12. A multi-stage complex bandpass-notch filter having a real signal input and a quadrature signal output, wherein multiple filter stages are connected in cascade and are operational amplifier (OpAmp) based complex bandpass filter stages, comprising: a first filter stage having a real signal input coupled to the real signal input of the multi-stage complex bandpass-notch filter and having a quadrature signal output, comprising a first OpAmp based complex bandpass filter stage and an open Q component of a quadrature signal input of the first OpAmp based complex bandpass filter stage; wherein the open Q component of the quadrature signal input of the first OpAmp based complex bandpass filter stage is predetermined to be high-impedance open; wherein an I component of the quadrature signal input of the first OpAmp based complex bandpass filter stage is coupled to the real signal input of the first filter stage, the quadrature signal output of the first OpAmp based complex bandpass filter stage is coupled to the quadrature signal output of the first filter stage; whereby the multi-stage complex bandpass-notch filter has bandpass frequency response in either positive or negative frequency domain and notch frequency response in the opposite frequency domain and applies to RF receivers and TV tuners to both bandpass-filter a desired signal and reject image and other interference signals.

13. The multi-stage complex bandpass-notch filter of claim 12 wherein the real signal input and the quadrature signal output of the multi-stage complex bandpass-notch filter are either differential or single-ended, respectively.

14. The multi-stage complex bandpass-notch filter of claim 12 wherein two identical feedback resistors connected respectively in parallel to two identical capacitors coupled to a Q component of the quadrature signal output of the first OpAmp based complex bandpass filter stage are predetermined as at least two times as large in value as two identical feedback resistors connected respectively in parallel to two identical capacitors coupled to an I component of the quadrature signal output of the first OpAmp based complex bandpass filter stage.

15. The multi-stage complex bandpass-notch filter of claim 14 further comprising one or more following filter stages; each of the following filter stages having a quadrature signal input and a quadrature signal output and predetermined as the OpAmp based complex bandpass filter stage; whereby the multi-stage complex bandpass-notch filter satisfies different design requirements of filter types and orders.

16. The multi-stage complex bandpass-notch filter of claim 15 wherein circuits of I and Q signal paths of the one of the following filter stages are symmetrical.
